(19) United States
(12) Patent Application Publication
(10) Pub. No.: US 2026/0148577 A1
(43) Pub. Date: May 28, 2026

(54) METHOD AND SYSTEM FOR MODIFYING IMAGES

(71) Applicant: Accenture Global Solutions Limited, Dublin (IE)

(72) Inventors: Abhishek SINGH, Deoghar (IN); Swati TATA, Bangalore (IN); Arjun ATREYA V, Bengaluru (IN); Krishna KUMMAMURU, Bengaluru (IN); Kamlesh Narayan CHAUDHARI, District Satara (IN); Divyayan DEY, Midnapore (IN); Kritik SOMAN, Bengaluru (IN); Daniel Shem FUERST, Los Angeles, CA (US); Srigururam SRINIVASAN, Dharmpuri District (IN); Krupa NOBILE, Scotch Plains, NJ (US); Abhishek Kumar SINGH, Gurgaon (IN); Neha MISRA, Chicago, IL (US); Nitish Kumar Bhuyan, Bhubaneswar (IN)

(73) Assignee: Accenture Global Solutions Limited, Dublin (IE)

(21) Appl. No.: 18/960,665

(22) Filed: Nov. 26, 2024

(51) Int. Cl. G06V 30/148; G06T 7/13; G06V 30/18; G06V 30/19

(52) U.S. Cl. CPC G06V 30/153; G06T 7/13; G06V 30/18143; G06V 30/19013

(57) ABSTRACT

Method, system, and computer-readable media for modifying images are disclosed. Main and reference image are received. Location points of content within main image that is candidate for match with reference image are determined. Main image and location points are processed using image segmentation foundation model to generate image mask. Image mask is received. First, degree of similarity between image mask and reference image is determined. Second, presence of reference image in main image at location points is determined, based on result of first determining. Modified image is generated from main image. Modified image is generated by one of removing reference image from main image when reference image is present in main image at allowable location, relocating location of reference image in main image when reference image is present in main image at unallowable location, or adding reference image to main image when reference image is absent in main image.

### TECHNICAL FIELD

Various examples described herein relate generally to computer-implemented method, computer system, and computer program product for modifying images.

### BACKGROUND

In a current digital environment, ensuring image compliance is critical across various industries, including marketing, trust and safety, healthcare, life sciences, and the like. The image compliance refers to adherence of images to established rules or guidelines and regulations governing a use and presentation of visual content in the images across the various industries. The image compliance involves ensuring that the images adhere to specific standards related to different content of the images, such as appropriateness of text and imagery, as well as technical specifications of the images like font properties, layout, colors, resolution, and size. Adhering to the specific standards may significantly impact brand reputation by fostering trust and credibility with customers, legal standing by mitigating risks associated with regulatory compliance, and overall revenue by enhancing customer engagement and conversion rates. As the digital environment continues to evolve, importance of the image compliance remains critical for industries aiming to protect their brand and succeed in competitive markets.

### SUMMARY

Implementations of the present disclosure are generally directed to modification of images using image processing techniques and Generative Artificial Intelligence (Gen AI) models. More particularly, implementations of the present disclosure are directed to generation of modified images based on compliance validation of the images according to a plurality of predefined rules or guidelines, ensuring that the modified images follow the plurality of rules or guidelines (e.g., regulatory requirements and branding guidelines).

In general, innovative aspects of the subject matter described in this specification provide a computer-implemented method for modifying an image. The computer-implemented method may include receiving a main image and a reference image. The computer-implemented method may further include determining one or more location points of content within the main image that may be a candidate for a match with the reference image. The computer-implemented method may further include processing the main image and the determined one or more location points using an image segmentation foundation model to generate an image mask. The computer-implemented method may further include receiving the image mask, in response to the processing. The computer-implemented method may further include first determining a degree of similarity between the received image mask and the reference image. The computer-implemented method may further include second determining, based on a result of the first determining, whether the reference image is present in the main image at the one or more location points. The computer-implemented method may further include generating, in response to at least the second determining, a modified image from the main image. The modified image may be generated by at least one of removing the reference image from the main image when the reference image is present in the main image at an allowable location, relocating a location of the reference image in the main image when the reference image is present in the main image at an unallowable location, or adding the reference image to the main image when the reference image is absent in the main image.

The present disclosure further describes a system for implementing the method provided herein. The present disclosure also describes computer-readable media coupled to one or more processors and having instructions stored thereon which, when executed by the one or more processors, cause the one or more processors to perform operations in accordance with the method described herein.

It is appreciated that methods in accordance with the present disclosure can include any combination of the aspects and features described herein. That is, the method in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

Various examples in accordance with the present disclosure will be described with reference to the drawings, in which:

FIG. 1 illustrates an example environment that may be used to execute implementations of the present disclosure.

FIG. 2 illustrates a block diagram of a system for modifying images, in accordance with implementations of the present disclosure.

FIG. 3 illustrates a process flow of generating various rules governing allowable content in images, in accordance with implementations of the present disclosure.

FIGS. 4A-4C illustrate example scenarios of determining location points within a main image, in accordance with implementations of the present disclosure.

FIG. 5 illustrates an example scenario of modifying an image, in accordance with implementations of the present disclosure.

FIG. 6 illustrates a process flow of validating compliance of visual content with textual descriptions, in accordance with implementations of the present disclosure.

FIG. 7 illustrates a process flow of providing a recommendation based on validating image compliance, in accordance with implementations of the present disclosure.

FIG. 8 illustrates an offline process flow of generating rules governing allowable content, in accordance with implementations of the present disclosure.

FIG. 9 illustrates an online process flow of providing recommendations based on compliance validation of the images, in accordance with implementations of the present disclosure.

FIG. 10 is a flow diagram that presents an example method for modifying images, in accordance with implementations of the present disclosure.

FIG. 11 is a flow diagram that presents an example method for determining location points within an image, in accordance with implementations of the present disclosure.

FIG. 12 is a flow diagram that presents an example method for determining location points within an image including textual data, in accordance with implementations of the present disclosure.

FIG. 13 is a flow diagram that presents an example method for determining location points for a low-resolution image, in accordance with implementations of the present disclosure.

FIG. 14 illustrates a computer system that may be used to implement an image modification system.

Like reference numbers and designations in the various drawings indicate like elements.

### DETAILED DESCRIPTION

In the following description, various examples will be illustrated by way of example and not by way of limitation in the figures of the accompanying drawings. References to various examples in this disclosure are not necessarily to the same examples, and such references mean at least one. While specific implementations and other details are discussed, it is to be understood that this is done for illustrative purposes only. A person skilled in the relevant art will recognize that other components and configurations may be used without departing from the scope of the claimed subject matter.

Reference to any “example” herein (e.g., “for example,” “an example of,” by way of an “example” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to limit the scope of the disclosure, examples of instruments, apparatus, methods, and their related results according to the examples of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to;” it specifically indicates open-ended inclusion or membership in the so-described combination, group, series, and the like.

The term “a” means “one or more” unless the context clearly indicates a single element.

“First,” “second,” etc., are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A. and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of examples. However, it will be understood by one of ordinary skill in the art that examples may be practiced without these specific details. For example, systems may be shown in block diagrams so as not to obscure the examples in unnecessary detail. In other instances, well-known processes, structures, and techniques may be shown without unnecessary detail in order to avoid obscuring example examples.

The specification and drawings are to be regarded in an illustrative rather than a restrictive sense. It will, however, be evident that various modifications and changes may be made thereunto without departing from the broader spirit and scope of the disclosure as set forth in the claims.

An image compliance process is essential in ensuring that visual content in an image adheres to pre-defined rules or guidelines associated with an industry vertical. The image compliance process involves multiple steps, starting with a careful evaluation of the image to ensure that the image meets the pre-defined rules or guidelines related to content, design, and technical specifications of the image. The pre-defined rules or guidelines dictate not only what is acceptable or allowable in terms of imagery and text but also set standards for various aspects such as layout, font properties, color schemes, resolution, size, and/or the like.

The pre-defined rules or guidelines serve as a framework for the industry to maintain high standards in visual communications. By adhering to the pre-defined rules or guidelines, industries protect their brand image, avoid potential legal issues, and ensure financial stability. For example, in a healthcare industry, images are required to accurately represent medical practices and respect confidentiality of patients. Furthermore, in marketing, images are required to align with brand messaging and ethical advertising practices.

Despite the importance of the image compliance process, manual review processes for image compliance face substantial challenges, particularly due to escalating complexity of compliance requirements. Industries face growing demands to ensure that the images adhere to a wide range of standards, necessitating a comprehensive assessment of various elements within each image. In the manual review processes, reviewers need to assess various factors including appropriateness of text in the image, a choice of fonts in the image, a layout and arrangement of components in the image, and overall quality of visual content in the image. Each of the factors is important in determining whether the image is suitable for its intended purpose. Further, a verification of an extensive number of elements (e.g., text blocks, font styles, sub-images, graphics, color and gradients, and the like) may be required, which makes thorough reviews of the elements time-consuming and prone to errors. Additionally, many of the pre-defined rules or guidelines are documented in lengthy texts or complicated online resources, complicating a review task for the reviewers who need to interpret and apply the pre-defined rules or guidelines (e.g., the rules or guidelines that are documented in lengthy texts or complicated online resources) consistently. Therefore, the complexity of the compliance process leads to non-compliance issues, resulting in serious consequences for the industries. The consequences include legal fines, loss of customer trust, and/or damage to brand reputation. The consequences further lead to decreased consumer trust and financial losses. For example, a healthcare provider using a non-compliant imagery in advertising may face penalties from regulatory agencies, while a marketing firm that misrepresents a product may lose customer confidence and loyalty.

The consequences associated with failing to the meet compliance requirements underscore a need for specialized expertise in the image compliance process, which is challenging to find within the industries relying on the manual processes. Additionally, understanding and interpreting the pre-defined rules or guidelines requires not only familiarity with specific rules but also an understanding of complexity of visual content and how the visual content resonates with various audiences.

The present disclosure addresses the challenges faced in the manual review processes through an automated approach to image compliance. The disclosure leverages a Generative Artificial Intelligence (Gen AI) model to transform verbose, unstructured guideline documents into model-compatible rules and configurations. The transformation facilitates a more straightforward interpretation of the compliance requirements, enabling the industries to streamline their review processes significantly.

In addition to enhancing the interpretation of the compliance requirements including the rules or the guidelines, the present disclosure incorporates a continuous feedback learning technique for topic modeling. The continuous feedback learning technique auto-selects processing pipelines based on various aspects such as a sector, a brand, a product, a market, a content type, and/or a geographic location. The present disclosure segments the image compliance process across different verticals and horizontals to ensure that the industries apply most relevant rules or guidelines efficiently and effectively. Here, the most relevant rules or guidelines refers to rules or guidelines that are most applicable or appropriate for a specific industry, sector, or context. It implies that not all rules or guidelines are equally important for every situation, instead, the present disclosure aims to ensure that the industries focus on specific rules or guidelines that best match their needs, goals, and the compliance requirements. The segmentation the image compliance process across different verticals and horizontals enhances efficiency and effectiveness of the image compliance process. For example, the healthcare provider may prioritize rules related to the patient confidentiality and medical practices, while the marketing firm may focus on rules related to the advertising ethics and brand messaging.

Moreover, the present disclosure focuses on optimal visual structure and object detection, by identifying, separating, and extracting various components of the images. By accurately detecting objects of interest such as brand logos and medical equipment, the present disclosure ensures a thorough validation of the image compliance process that aligns visuals with textual rules or guidelines. Also, the present disclosure establishes a robust correlation between image content and text, allowing for custom validations that detect compliance failures. Through the image processing and analysis techniques, the present disclosure generates modified images that meet regulatory standards, ensuring adherence to both branding and federal regulations across various industry verticals.

To summarize, the present disclosure provides a solution to the existing challenges in the image compliance process by automating interpretation of the rules or guidelines, enhancing detection capabilities, and facilitating continuous learning. The present disclosure not only mitigates the risks associated with non-compliance but also fosters greater confidence in the integrity of visual content across various industries.

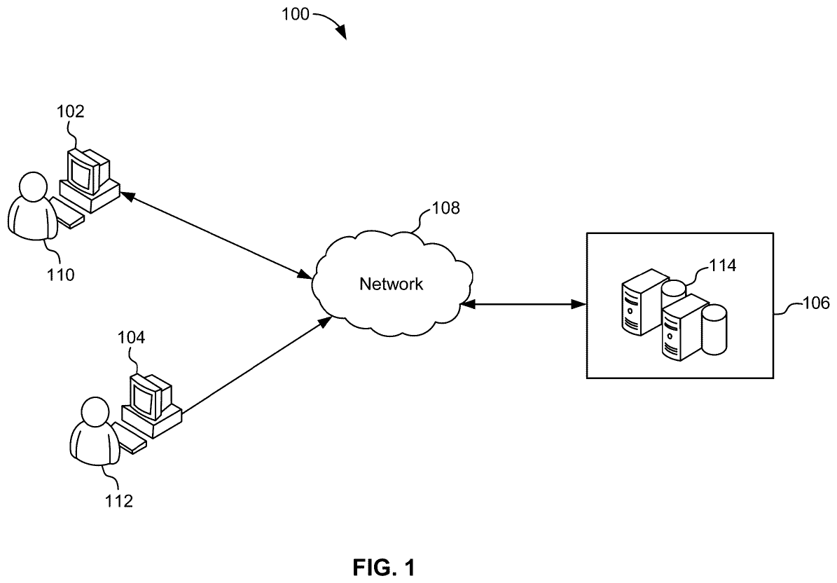

FIG. 1 illustrates an example environment 100 that may be used to execute implementations of the present disclosure. In some examples, the example environment 100 enables modification of images. For simplicity, implementations of the present disclosure are further described by considering images. However, it should be noted that implementations of the present disclosure are applicable to videos (including a sequence of images), text data, and/or audio data.

As depicted in FIG. 1, the example environment 100 includes computing devices 102 and 104, a back-end system 106, and a network 108. In some examples, the computing devices 102 and 104 are used by users 110 and 112 (e.g., administrators) respectively, to log into and interact with computing platforms executing applications according to implementations of the present disclosure. Examples of the computing devices 102 and 104 may include a server, a notebook, a desktop, a netbook, smartphones, laptops, a tablet, and/or voice-enabled devices. It is contemplated that implementations of the present disclosure may be realized with any appropriate type of computing device. In some examples, each of the computing devices 102 and 104 may include a web browser application executed thereon, which may be used to display one or more web pages of a computing platform executing applications. In some examples, each of the computing devices 102 and 104 may display one or more Graphical User Interfaces (GUIs) that enable the users 110 and 112 respectively, to interact with the computing platform.

In some examples, the network 108 may correspond to a communication network. Examples of the network 108 may include, but are not limited to, a Local Area Network (LAN), a Wide Area Network (WAN), the Internet, Wi-Fi, Long Term Evolution (LTE), Worldwide Interoperability for Microwave Access (WiMAX), General Packet Radio Services (GPRS), or a combination thereof. The network 108 communicatively couples or connects the computing devices 102 and 104 with the back-end system 106. In some examples, the network 108 may be accessed over a wired and/or a wireless communication link. For example, a computing device like smartphone may utilize a cellular network to access the network 108.

In some examples, the back-end system 106 may be implemented as an on-premises system that is operated by an enterprise or a third-party engaged in cross-platform interactions and data management. In some examples, the back-end system 106 may be implemented as an off-premises system (for example, a cloud or an on-demand system) that is operated by an enterprise or a third-party on behalf of an enterprise. In some examples, the back-end system 106 may be implemented in a cloud environment. For simplicity, the back-end system 106 depicted in FIG. 1 may be a cloud environment that is intended to represent various forms of servers including a web server, an application server, a proxy server, a network server, a server pool, and/or the like.

In some examples, the back-end system 106 includes an image compliance and modification system 114. The image compliance and modification system 114 may host components of enterprise systems and applications (e.g., a system designed to assess image compliance in a marketing firm and an associated application). Also, the image compliance and modification system 114 exchanges information with the users 110 and 112 through the computing devices 102 and 104, respectively, enabling delivery of various services. By way of an example, the users 110 and 112, through the computing devices 102 and 104 respectively, may provide the information including an image or documents (e.g., a main image and a reference image) for compliance assessment. By way of another example, the users 110 and 112, through the computing devices 102 and 104 respectively, may receive the information including a modified or updated image that adheres to relevant rules or guidelines based on results of the compliance assessment.

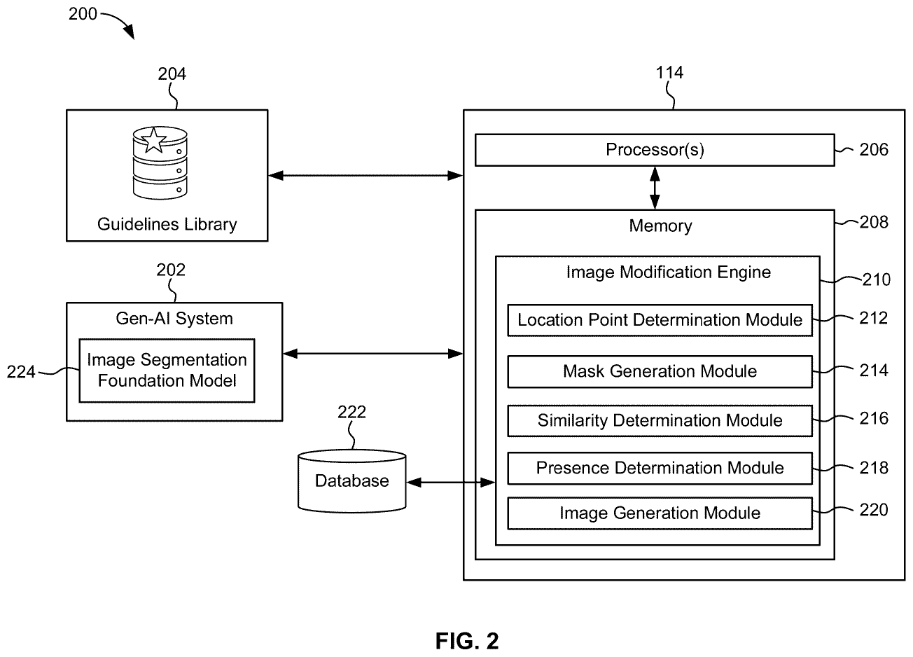

In some examples, based on the received image (e.g., the main image and the reference image), location points of content within the main image may be determined by the image compliance and modification system 114. The main image and the location points may be used as a mode of interaction with a Gen AI system (as depicted in FIG. 2) to perform one or more tasks. For example, a task may be generation of an image mask. Further, the image compliance and modification system 114 may utilize the generated image mask for the compliance assessment and, if required, generate a modified image based on the results of the compliance assessment.

According to implementations of the present disclosure, the image compliance and modification system 114 may be adapted for performing the compliance assessment and accordingly modifying the images, which is described in detail in conjunctions with figures below.

FIG. 2 illustrates a block diagram of a system 200 for modifying images, in accordance with implementations of the present disclosure. FIG. 2 is explained in conjunction with FIG. 1. As depicted in FIG. 2, the system 200 includes the image compliance and modification system 114, a Gen AI system 202, and a guidelines library 204.

The image compliance and modification system 114 includes processor(s) 206 and a memory 208. The processor(s) 206 may include, for example, microprocessors, microcomputers, microcontrollers, digital signal processors, central processing units, state machines, logic circuits, and/or any devices that manipulate data or signals based on operational instructions. The memory 208 may be a non-volatile memory or a volatile memory. Examples of the non-volatile memory may include, but are not limited to, a flash memory, a Read Only Memory (ROM), a Programmable ROM (PROM), Erasable PROM (EPROM), and Electrically EPROM (EEPROM) memory. Examples of the volatile memory may include, but are not limited, a Dynamic Random Access Memory (DRAM), and a Static Random-Access Memory (SRAM).

The memory 208 may be communicatively coupled to the processor(s) 206. The memory 208 stores instructions, which upon execution by the processor(s) 206, cause the processor(s) 206 to perform various operations described in the present disclosure. The memory 208 includes an image modification engine 210. The instructions stored in the memory 208 may define operations of the image modification engine 210. The image modification engine 210 includes a location point determination module 212, a mask generation module 214, a similarity determination module 216, a presence determination module 218, and an image generation module 220.

In an implementation, the image modification engine 210 may be coupled to a database 222. The database 222 may store various data and intermediate results generated by the components 212-220. For example, the database 222 may store images received from the users 110 and 112 via the computing devices 102 and 104 respectively, information generated regarding location points, various rules and guidelines selected for a particular image compliance process, image masks, results of compliance assessment and/or the like, which are described in detail below.

The Gen AI system 202 includes an image segmentation foundation model 224. An example of the image segmentation foundation model 224 includes a Segment Anything Model (SAM). The image segmentation foundation model 224 and the SAM are used interchangeably in accordance with implementations of the disclosure. In some implementations, the Gen AI system 202 includes a hosting infrastructure (not depicted in FIG. 2) to host the image segmentation foundation model 224. Examples of the hosting infrastructure may include cloud computing platforms or the like. In some examples, image segmentation foundation model 224 may be provided by one or more third parties. In some other examples, image segmentation foundation model 224 may be provided by one or more enterprises (such as a marketing firm), which deploys the image compliance and modification system 114.

The image segmentation foundation model 224 may be used to analyze visual content by dividing images into distinct segments or regions based on the features and characteristics of the images. The image segmentation foundation model 224 may be further used to identify and separates various objects within an image for tasks such as object detection and compliance assessment. The image segmentation foundation model 224 is trained on a diverse dataset of annotated images to recognize and define various objects and segments or regions effectively. The image segmentation foundation model 224 is trained to perform image segmentation effectively by leveraging various input modalities, including bounding boxes, key points, and the like. Further, the image segmentation foundation model 224 may be accessed through an Application Programming Interface (API), which serves as a gateway for receiving requests or images. While implementations of the present disclosure are described in further detail herein with non-limiting reference to the image segmentation foundation model, it is contemplated that implementations of the present disclosure may be realized using any appropriate foundation models/Large Language Models (LLMs) or Machine Learning (ML) models, or Artificial Intelligence (AI) models.

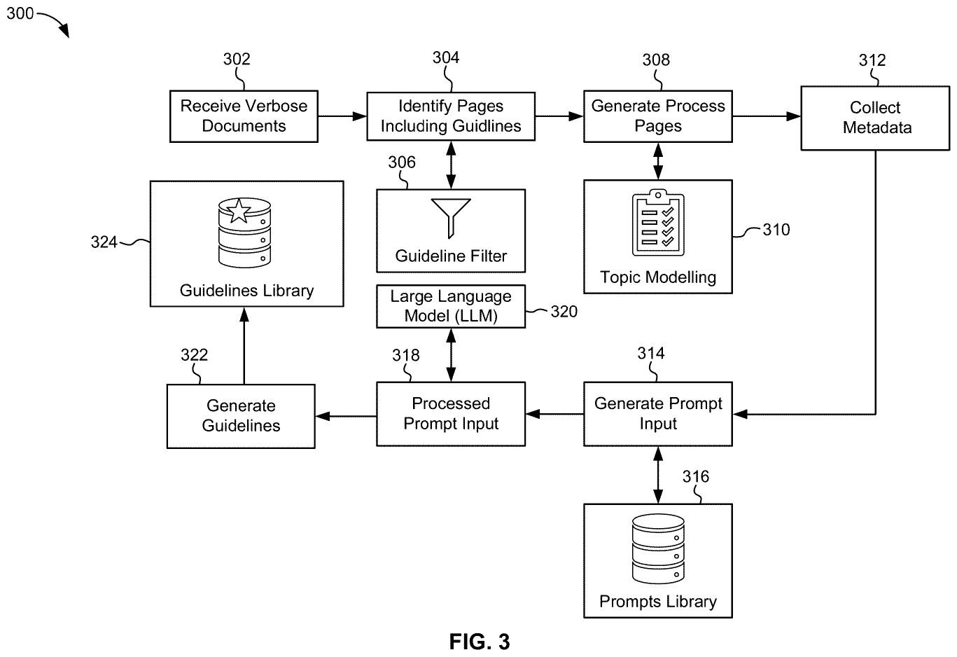

The guidelines library 204 is a comprehensive repository that consolidates pre-defined rules or guidelines for the compliance assessment of the images across various industries. The guidelines library 204 is generated through a systematic process that involves gathering information by identifying guideline-containing pages, extracting and categorizing content via topic modeling, gathering relevant metadata, and converting the information into a structured and machine-interpretable format suitable for processing with the image segmentation foundation model 224. Generation of the guidelines library 204 is explained in detail in conjunction with FIG. 3.

In some implementations, a continuous feedback learning mechanism for topic modeling may be implemented to automatically select the rules, based on various factors. The factors may include, but are not limited to, a sector, a brand, a product, a market, and a content type. Further, the rules may be segregated at a finer level across different industry verticals, and geo-location data may be incorporated to refine the rules selection for specific regions. Examples of the industry verticals may include, but are not limited to, banking, life sciences, sports, email, banner advertisements, and e-detailing.

For the compliance assessment, the location point determination module 212 may receive a main image and a reference image from the users 110 and 112 through the computing devices 102 and 104 respectively. The main image is a primary image that is subjected to analysis and modification. The users 110 and 112 may provide the main image to alter, enhance, or evaluate the main image based on specific rules. The reference image is a secondary image used as a benchmark or standard for comparison against the main image. The reference image may include specific content, features, or patterns that are checked against the main image. Upon receiving the main image and the reference image, the location point determination module 212 may determine location points of content within the main image that may be candidate for a match with the reference image. The location points may refer to specific coordinates or regions of the content within the main image that indicate areas of interest for further analysis or comparison. The location points serve as reference markers for identifying where specific elements such as text, objects, or other relevant features are located. For example, in a scenario where the main image is compared with the reference image, the location points may highlight areas in the main image that may include content similar to that in the reference image.

In other words, the location point determination module 212 may determine the location points based on the content that needs to be assessed for compliance within the main image and/or the reference image. The content to be assessed refers to the specific elements, objects, and/or areas within the main image that need to be evaluated for compliance with predefined rules or guidelines. The content to be assessed may include the text, the objects, graphics, or any visual elements that need to meet certain standards.

For example, in an implementation, the content to be assessed and/or the reference image is a clear image of an object with appropriate size, and/or high or moderate resolution, quality, texture, and/or transparency. In such a case, the main image and the reference image may be processed using a scale invariant transformation function. In some examples, the appropriate size, resolution, quality, texture, and transparency may be determined based on corresponding predefined threshold values stored in the guidelines library 204. The scale invariant transformation function may be applied on the given image (e.g., the main image and the reference image) to identify key points, which are scale invariant. Using the scale invariant transformation function, relevant portions of the image may be compared even if a size of the main image does not match a size of the reference image.

The scale-invariant transformation function ensures that comparison between the main image and the reference image remains accurate, regardless of size or orientation of the main image and the reference image. When analyzing the main and reference images, differences in scales of the main image and the reference image may arise from various factors, such as a distance from which the main and reference images are captured or variations in camera settings. Additionally, the main and reference images may be rotated or presented at different angles, further complicating direct comparisons. The scale invariant transformation function normalizes the main image and the reference image, allowing for a consistent reference point when analyzing content (e.g., visual elements and features within the main image and reference image). The scale-invariant transformation function adjusts both the main image and the reference image to a common scale and orientation, effectively eliminating discrepancies that may lead to inaccuracies in image compliance assessment process. By the adjustment, the scale-invariant transformation function enables the location point determination module 212 to accurately identify corresponding elements in both the main and reference images, facilitating a more reliable evaluation of compliance with the predefined rules or guidelines.

After applying the scale-invariant transformation function to the main image and the reference image, the location point determination module 212 may process the transformed main image and the reference image to identify the coordinates, regions or the location points that require assessment for compliance. The processing involves extracting distinct features such as edges and contours from both the transformed main image and reference image and using pattern recognition methods to match corresponding features. An outcome of the processing may be a set of location points that indicate the areas of interest in the main image that need to adhere to the predefined rules or guidelines.

In another implementation, the content to be assessed and/or the reference image may be a text. In such a case, the location point determination module 212 may first scan the main image using an Optical Character Recognition (OCR) technique to extract main image text. The location point determination module 212 may second scan the reference image using the OCR technique to extract reference image text. In some implementations, the scanning of the main image and reference image may be performed simultaneously. In some other implementations, the scanning of the reference image is performed first, and the scanning of the main image is performed second, and vice-versa. Further, the location points for a region in the main image that encloses text within the main image text matching the reference image text may be determined. The determination of the location points includes comparing the extracted main image text against the reference image text to identify matches. Further, geometric analysis may be performed to evaluate spatial coordinates of matching text segments, leading to identification the region that enclose the text in the main image which matches the reference text.

In yet another implementation, the content to be assessed or the reference image may be an image of an object which is extremely small in size and/or has low resolution or poor quality (e.g., a blur image), which are determined based on corresponding predefined threshold values stored in the guidelines library 204. In such a case, the location point determination module 212 may use an edge detector program to generate a black and white version of the main image and the reference image. The edge detector program may correspond to an image processing tool that may identify and highlight boundaries or edges within the main and the reference images, marking significant changes in intensity or color. The edge detector program may analyze pixel values of the main image or the reference image to determine where sharp transitions occur in the main and the reference image, effectively outlining objects within the main and the reference images. To generate the black and white versions of the main image and the reference image, the edge detector program may convert original main image and reference image into a grayscale main image and a reference image, simplifying color information to intensity values. Further, the edge detection program may apply a thresholding technique, where pixels above a certain intensity are turned white (indicating edges), and pixels below the certain intensity are turned black (indicating background), resulting in binary images that clearly define edges of the objects in the main image and the reference image.

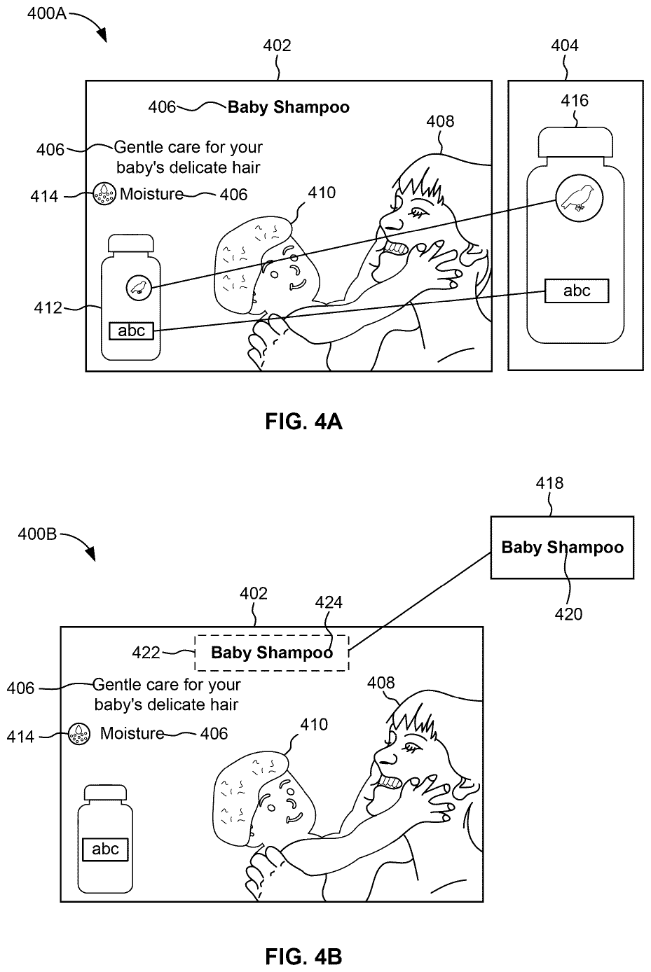

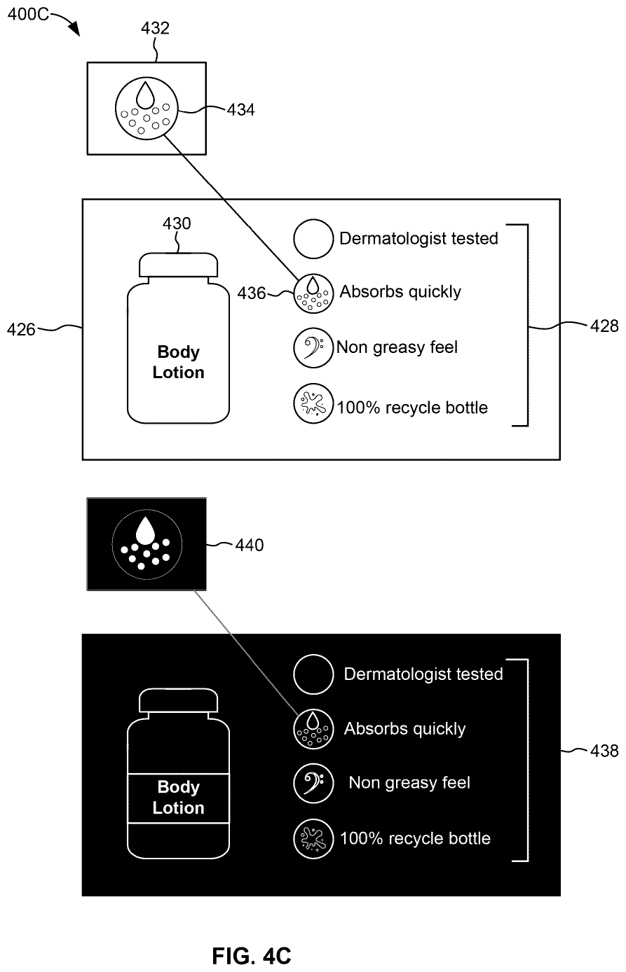

Further, the location point determination module 212 may process the black and white version of the main and reference images using the scale invariant transformation function, which has been already explained in detail in previous implementations in detail, therefore repeated description is omitted herein for sake of brevity. Based on the processing of the black and white version of the main and the reference images, the location point determination module 212 may determine the location points of the content or object within the main image. Exemplary illustrations of determining the location points are depicted in conjunction with FIGS. 4A-4C. The location point determination module 212 is communicatively coupled to the mask generation module 214. The scale invariant transformation function and the edge detection program may be executed sequentially. Further, outputs generated using each of the scale invariant function and the edge detection program may be ensembled to generate a final output including the location points.

The mask generation module 214 may receive the main image and the location points from the location point determination module 212. Further, the mask generation module 214 may process the main image and the location points using the image segmentation foundation model 224 to generate an image mask. In particular, the mask generation module 214 receives two primary inputs including the main image (e.g., an original image that requires compliance assessment or further modification), and the location points (e.g., specific coordinates or regions identified in the main image for further analysis). The location points indicate areas within the main image that may correspond to features present in the reference image. The mask generation module 214 analyzes the main image and distinguish between various components based on their visual characteristics using the image segmentation foundation model 224. Further, the mask generation module 214, using the image segmentation foundation model 224, may identify textures, colors, shapes, and patterns, enabling it to define different objects or areas within the main image. The mask generation module 214 may utilize the identified location points to analyze specific regions of the main image using the image segmentation foundation model 224. The specific regions may be processed to determine characteristics of the regions and how the regions relate to a broader content of the main image. Based on analyzation, the image mask may be generated. The image mask may highlight the areas of interest in the main image. The image mask may be a binary representation of the main image, where pixels corresponding to the identified regions of interest are marked (e.g., in white) while all other pixels are set to a background value (e.g., black). The mask generation module 214 may output a visual representation (e.g., the image mask) that clearly defines which parts of the main image needs to be focused on during subsequent processing. The mask generation module 214 may be communicatively coupled to the similarity determination module 216.

Further, the similarity determination module 216 may receive the image mask and determine a degree of similarity between the generated image mask and the reference image by analyzing the image mask and the reference image. To determine the degree of similarity, the image mask may be applied to the main image. By applying the image mask, specific areas of the main image may be isolated based on the image mask. For example, if the image mask may be applied to the main image to create a new image that retains only relevant areas defined by the image mask. After applying the image mask, content from the main image that corresponds to the areas of interest may be extracted. The extraction may produce a “masked image” that includes only the areas of the main image that overlap with non-zero areas of the image mask. Further, the masked image may be compared with the reference image.

The comparison involves examining both pixel-level and feature-level correspondences between the masked image and the reference image, considering factors such as pixel values, shape, color, luminance, contrast, texture, spatial arrangement of elements within the image mask and the reference image, and/or the like. For the comparison, the similarity determination module 216 may use one of techniques such as Normalization Cross-Correlation (NCC), feature similarity index, histogram comparison, Earth Mover's Distance (EMD), Cosine similarity, Hamming distance, Jaccard Index, and the like. In some implementations, the degree of similarity may correspond to a cumulative similarity score. The cumulative similarity score or the degree of similarity may be determined based on similarity scores and degree of similarity determined for each of the factors. The degree of similarity may include a range of values 0 to 1 and/or a range of percentages 0% to 100%. For example, the degree of similarity or cumulative similarity score of 1 or 100% indicates that the image mask is completely similar to the reference image. The degree of similarity or the cumulative similarity score of 0 or 0% indicates that the image mask is completely different from the reference image. Further, the degree of similarity or the cumulative similarity score of 0.8 or 80% indicates that the image mask is partially similar to the reference image. Therefore, the cumulative similarity score or the degree of similarity may be a measure of how similar visual elements of the image mask are to visual elements of the reference image. The similarity determination module 216 may be communicatively coupled to the presence determination module 218.

Based on the degree of similarity or results of similarity determination, the presence determination module 218 may determine a presence of the reference image in the main image at the location points. For example, the presence determination module 218 may compare the degree of similarity or the cumulative similarity score with a predefined threshold. When the degree of similarity is below the pre-defined threshold, the reference image may be absent in the main image at the location points. Conversely, when the degree of similarity is above or equal to the pre-defined threshold, the reference image may be present in the main image. The comparison confirms that the visual content of the main image at the location points matches (e.g., closely resembles) the reference image, or there is a mismatch between the visual content of the main image at the location points and the reference image. By way of an example, consider a scenario where the predefined threshold is 0.5 or 50%. In such a case, the degree of similarity or the similarity score above or equal to the 0.5 or 50% may indicate that the reference image is present in the main image at the location points. The degree of similarity or the similarity score below the 0.5 or 50% may indicate that the reference image is absent in the main image at the location points. The presence determination module 218 may be communicatively coupled to the image generation module 220.

The image generation module 220 may generate a modified image based on the determination of the presence of the reference image in the main image at the location points. Various rules may be maintained in the database 222 that govern allowable and/or required content in an image may be maintained using the guidelines library 204. In an implementation, when the reference image is present in the main image at an allowable location, the image generation module 220 may determine if the reference image in the main image violate any of the rules that prohibit presence of the reference image. In response to a successful determination that the reference image in the main image violate any of the rules, the image generation module 220 may remove the reference image from the main image. In another implementation, when the reference image is present in the main image at an unallowable location, the image generation module 220 may determine if the reference image present at a location in the main image in violation any of the rules that limit allowable locations of the reference image. In response to a successful determination that the reference image present at a location in the main image in violation any of the rules that limit allowable locations of the reference image, the image generation module 220 may relocate the reference image in the main image. In yet another implementation, when the reference image is absent in the main image, the image generation module 220 may add the reference image to the main image.

By way of an example, a company is specialized in cruelty-free products and emphasize its commitment to animal welfare and ethical sourcing. To uphold a brand image, there are some specific rules or guidelines are maintained that dictate how products and representatives associated with the company may be presented. The rules or the guidelines may include ensuring that all promotional materials reflect cruelty-free ethos of brand, requiring employees and brand ambassadors to wear clothing that aligns with values, and avoiding any visuals that may contradict a message of compassion towards animals.

In a recent advertisement, the company features a well-known brand ambassador promoting latest line of skincare products of the company. However, the brand ambassador is wearing a leather jacket in the advertisement. To ensure compliance of the advertisement with rules or guidelines associated with the company (maintained in the database 222), before broadcasting the advertisement, the company may use the image compliance and modification system 114 to verify whether the advertisement adheres to all relevant rules or if any modifications are needed. The image compliance and modification system 114 may process the main image and the reference image associated with the advertisement (for example, images of the brand ambassador promoting the latest line of skincare product). Further, the presence of the reference image in the main image at the location points may may be determined successfully through the image compliance and modification system 114 using various components 212-218 as described above. Once the presence is determined successfully, the image compliance and modification system 114 may determine if the main image is violating any of the rules or guidelines maintained for the company. During the determination of violation, the image compliance and modification system 114 may find that the image includes the leather jacket, which conflicts with an ethical apparel rule or guideline associated with the company. In this case, the leather jacket needs to be removed from the main image. Therefore, the image compliance and modification system 114 may remove the leather jacket from the main image, as ideally in the main image. the brand ambassador needs to be in clothing made from cruelty-free materials, such as vegan leather or organic cotton, showcasing a look that resonates with the rules or guidelines of the company.

FIG. 3 illustrates a process flow 300 of generating various rules governing allowable content in images, in accordance with implementations of the present disclosure. FIG. 3 is explained in conjunction with FIGS. 1-2. The process flow 300 may be executed using the image compliance and modification system 114.

The process flow 300 includes receiving verbose documents 302. The verbose documents 302 include extensive textual data. The textual data may potentially encompass guidelines, instructions, and other relevant content. Examples of the verbose documents 302 may include, but are not limited to, healthcare regulation manuals, financial institution compliance handbook, advertising code of practice, educational institution policy document, manufacturing safety standards document, and/or data protection and privacy policy.

The process flow 300 further includes identifying pages 304 that includes guidelines by filtering the verbose documents 302 through a guideline filter 306. The guideline filter 306 may be one or more of a font-based guideline filter, a font-size based guideline filter, a font-color based guideline filter, image-based guideline filter, an image-height-based guideline filter, an image-width-based guideline filter, an aspect-ratio-based guideline filter, and/or the like. With regards to filtering, the guideline filter 306 may parse the text within the verbose document. For parsing, the guideline filter 306 scans through the verbose documents and looks for keywords and phrases associated with specified attributes (e.g., font, font-size, font-color, and/or the like). The guideline filter 306 employs a predefined criteria to isolate pertinent information (e.g., rules and guidelines) while discarding irrelevant sections which is not related to guidelines.

Upon identification of the pages 304, the process flow 300 includes generating processed pages 308 by processing the pages 304 using a Natural Language Processing (NLP) technique, for example topic modeling 310, to extract and categorize content of the pages 304. The topic modeling 310 leverages statistical methods (such as Latent Dirichlet Allocation or Non-negative Matrix Factorization) to discern latent topics within the content, facilitating thematic organization. The process flow 300 further includes collecting metadata 312 associated with the extracted content from the processed pages 308. The metadata 312 includes contextual information (e.g., document purpose, target audience, and/or the like) and structural information (e.g., headings, subheadings, formatting attributes, and/or the like), providing a multi-dimensional view of the content. For example, the metadata 312 may include a domain, a guideline parent, and/or a medium.

The process flow 300 includes generating a prompt input 314 using the verbose documents 302, the metadata 312, and prompts selected from a prompts library 316. The prompt input 314 may be structured as questions or directives. The process flow 300 includes generating a processed prompt input 318 by processing the prompt input 314 using a Large Language Model (LLM) 320. In response to generating the processed prompt input 318, the process flow 300 includes generating guidelines 322 governing allowable content using the LLM 320. The guidelines 322 may be further stored in a guidelines library 324, which may be used by the image compliance and modification system 114 when required (e.g., for the compliance assessment).

FIG. 4A-4C illustrate example scenarios 400A, 400B, and 400C of determining location points within a main image, in accordance with implementations of the present disclosure. FIGS. 4A-4C are explained in conjunction with FIGS. 1-3.

Referring to FIG. 4A, a main image 402 and a reference image 404 are depicted. The main image 402 represents an advertisement for a baby soap, prominently displaying various elements, for example, main image text 406, a mother 408 holding a baby 410, a shampoo bottle 412, and a droplet 414. The reference image 404 which is a standard for comparison against the main image 402 includes a bottle 416. The shampoo bottle 412 and the bottle 416 have clear texture and transparency, making the shampoo bottle 412 and the bottle 416 easily identifiable. Therefore, in this case, the main image 402 and the reference image 404 may be processed using the scale invariant transformation function to receive the location points associated with the shampoo bottle 412 within the main image 402 that are the candidate match for the reference image 404. The processing of images using the scale invariant transformation function is explained in detail in conjunction with FIG. 2.

Referring to FIG. 4B, the main image 402 and a reference image 418 are depicted. In this case, the reference image 418 is the standard for comparison against the main image 402. The reference image 418 includes text. Therefore, in this case, first the main image 402 may be processed using an OCR technique to extract main image text 406. Further, the reference image 404 may be processed using the OCR technique to extract a reference image text 420. Further, the location points for a region 422 in the main image 402 that encloses a text 424 within the main image text 406 matching the reference image text 420 may be determined. The location points may be a candidate match with the reference image 418.

Referring to FIG. 4C, a main image 426 which includes a bottle 430 of body lotion and corresponding specifications 428, and a reference image 432 are depicted. In this case, the reference image 432 is the standard for comparison against the main image 426. The reference image 432 includes a droplet 434. A droplet 436 within the main image 426 and the droplet 434 of the reference image 432 has low texture and transparency. In this case, black and white versions 438 and 440 of the main image 426 and the reference image 432, respectively, may be generated using an edge detector program. Further, the black and white versions 438 and 440 of the main image 426 and the reference image 432, respectively, may be processed using the scale invariant transformation function. Based on the processing of the black and white versions 438 and 440 of the main image 426 and the reference image 432, the location points of the droplet 436 within the main image 426 may be determined. The location points of the droplet 436 may be a candidate match with the reference image 432.

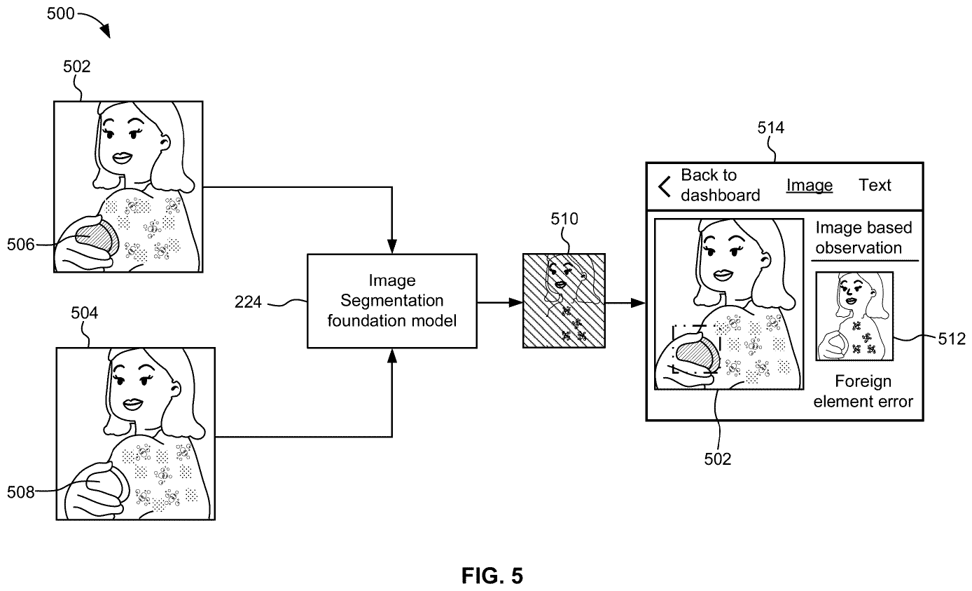

FIG. 5 illustrates an example scenario 500 of modifying an image (e.g., a main image 502), in accordance with implementations of the present disclosure. FIG. 5 is explained in conjunction with FIGS. 1-4a-4c.

The scenario 500 includes the main image 502, the reference image 504, the image segmentation foundation model 224. The main image 502 includes a pink soap 506 while the reference image 504 include a white soap 508. To analyze the main image 502 and the reference image 504, the main image 502 and the reference image 504 may be processed using the image segmentation foundation model 224. In particular, the image segmentation foundation model 224 may utilize the main image 502 and the location points for the pink soap 506 within the main image 502 determined using one of the techniques as described in previous FIGS. 1-4. The image segmentation foundation model 224 may generate an image mask 510 highlighting pink color of the soap within the main image 502. Further, a similarity between the image mask 510 and the reference image 504 may be determined. Further, based on the similarity determination, a modified image 512 may be generated. Both the main image 502 and the modified image 512 are then rendered on a user interface (UI) 514. The UI 514 may display a notification indicating a color discrepancy that the main image 502 originally depicted the soap in pink, whereas the modified image 512 indicates that color needs to be white. The notification may be displayed to inform a user about identified error, facilitating necessary adjustments. For example, the user may use the modified image 512 instead of the main image 502.

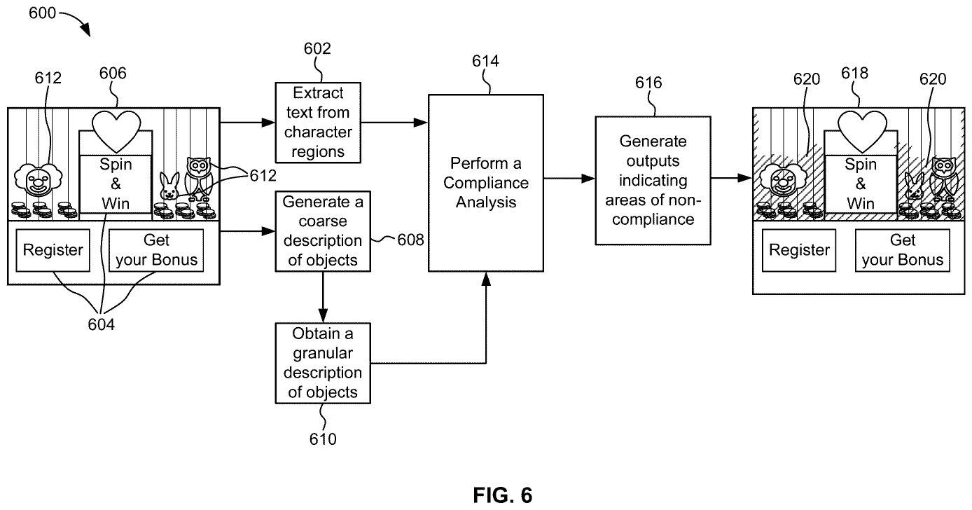

FIG. 6 illustrates a process flow 600 of validating compliance of visual content (e.g., objects in images and videos) with textual descriptions, in accordance with implementations of the present disclosure. The process flow 600 ensures that representation of the objects within the images or videos aligns with accompanying text. FIG. 6 is explained in conjunction with FIGS. 1-5. The process flow 600 may be executed using the image compliance and modification system 114.

The process flow 600 includes extracting texts 602 from character regions 604 in an image 606. A character segmentation model (not depicted in FIG. 6) may be used to identify and segment the character regions 604 within the image 606 that includes characters or text. The character segmentation model may accurately define where text appears, especially in areas where the text overlaps with the objects within the image 606. An example of the character segmentation model may include one or more of an LLM, an AI model, an ML model, and/or the like. Once the character regions 604 are identified, an OCR may be applied to extract the texts 602 or textual content from the character regions 604. Images of the texts 602 at the character regions 604 may be converted into machine-encoded text using the OCR, enabling further processing and analysis.

The process flow 600 further includes generating a coarse description of the objects 608 present in the image 606 based on the texts 602. A vision foundation model is prompted to analyze the texts 602 derived using the OCR. The vision foundation model uses the texts 602 to identify and describes various objects depicted in the image 606, producing a preliminary or the coarse description of the objects 608. An example of the vision foundation model may include one or more of: the LLM, the AI model, the ML model, and/or the like. The preliminary or coarse description of the objects 608 serves as an initial insight into the visual elements, while categorizing the visual elements into broad categories such as “bottle,” “child,” or “tree.” While the coarse description of the objects 608 provides valuable context, the coarse description of the objects 608 does not provide specifics of characteristics of each object, setting a stage for more detailed analysis in subsequent steps.

The process flow 600 further includes obtaining a granular description of the objects 610, enhancing detail and accuracy of the coarse description of the objects 608. To facilitate the granular description of the objects 610, regions 612 including the objects may be cropped from the image 606. The cropping process isolates objects of interest, allowing for a more precise analysis. After cropping the regions 612, the granular description of the objects 610 within the cropped objects may be generated using the vision foundation model. The granular description of the objects 610 encompasses various attributes, including color, size, texture, and other distinguishing features. By transitioning from the coarse description of the objects 608 to the granular description of the objects 610, a comprehensive understanding of the visual elements or the object may be ensured, which is essential for the subsequent compliance analysis.

Further, the process flow 600 includes performing a compliance analysis 614, where both the extracted texts from the character regions 604 and the granular description of the objects 610 are evaluated against a predefined set of rules or guidelines. The rules or the guidelines dictate expected relationships and alignments between the textual descriptions and the visual content in the image 606. By systematically comparing the texts 602 extracted from the character regions 604 and the granular description of the objects 610 with the rules or guidelines, any discrepancies or areas of non-compliance may be identified.

Once the compliance analysis 614 is performed, the process flow 600 includes generating outputs 616 (e.g., an output image 618) that indicate the areas of non-compliance (e.g., the areas 620 in the output image 618). If the texts 602 from the character regions 604 does not align with the rules or the guidelines, a corresponding character region including problematic text may be rendered as an output, effectively highlighting an issue for review. Conversely, if the granular description of objects 610 fails to meet any of the rules or guidelines, a corresponding cropped object region may be outputted to draw attention to specific visual element in question. The process flow 600 provides information of compliance failures, delivering clear visual cues for areas that require further attention or adjustment.

In other words, a thorough assessment of the image 606 may be performed to determine whether the image 606 includes any elements that violate the rules or the guidelines. The assessment includes a comprehensive review of both the texts 602 and the identified visual components for any discrepancies that may render the image 606 non-compliant. If any violations are detected, a conclusion may be drawn that the image 606 is prohibited from use based on the specific compliance rules and guidelines.

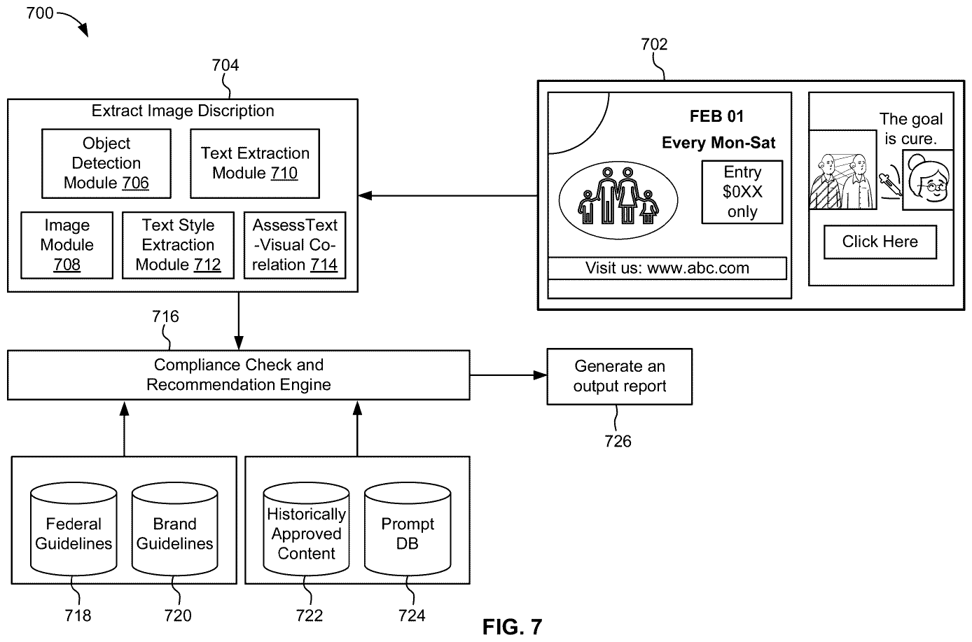

FIG. 7 illustrates a process flow 700 of providing a recommendation based on validating image compliance, in accordance with implementations of the present disclosure. FIG. 7 is explained in conjunction with FIGS. 1-6. The process flow 700 may be executed using the image compliance and modification system 114.

The process flow 700 includes receiving an image 702. The image 702 may include textual data and various objects. The process flow 700 further includes extracting image description 704 from the image 702. To extract the image description 704, various sub-steps may be performed using various modules 706-714 as described further. To extract the image description 704, an object detection module 706 may be enabled for identifying various elements within the image 702, such as persons, logos, objects, emotions, and even demographic indicators like age. By leveraging machine learning (ML) models, the object detection module 706 analyzes visual content of the image 702 to locate and classify the elements of the image 702 accurately. Further, to extract the image description 704, an image module 708 may be employed which analyzes visual properties of the image 702. The analyzation includes identifying background colors, image resolutions, and compositional elements. The visual properties are essential for understanding aesthetic quality and overall presentation of the image 702.

Further, to extract the image description 704, a text extraction module 710 may be enabled. The text extraction module 710 utilizes an OCR technique to extract textual data embedded within the image 702. The utilization of OCR is particularly useful in cases where text is integrated with visual elements, such as logos or labels. Additionally, a text style extraction module 712 may be employed to extract typographical aspects of the textual data extracted from the image 702. The text style extraction module 712 identifies attributes such as font style, font family, font size, and/or font color.

Further, with the textual data and visual elements extracted and analyzed, a text-visual correlation 714 may be assessed. The assessment involves determining how well the textual data aligns with the visual elements identified in the image 702. A strong correlation indicates that the textual data accurately describes the visual elements.

Once the image description 704 is extracted, a compliance check and recommendation engine 716 may be enabled. The compliance check and recommendation engine 716 utilizes one or more of: a foundation model/LLM, an AI model, an ML model, and/or the like, to evaluate the image 702 against various compliance standards, including federal guidelines 718, brand guidelines 720, and historically approved content 722. The compliance check and recommendation engine 716 extracts dimensions and business rules relevant for compliance, analyzing how well the image 702 adheres to specified requirements outlined in web pages, manuals, and design templates. A prompt database 724 may also be utilized to guide the compliance assessment, providing context and criteria for evaluation.

The process flow 700 includes generating an output report 726 that indicates various issues identified during the compliance check and suggestions to overcome the issues. For examples, the output report 726 may indicate a total of six issues and corresponding six suggestions. For a title block with coordinates (L₁ (left), T₁(top), R₁(right), B₁(bottom)), the output report 726 indicates two issues and corresponding suggestions, including a first issue, a first suggestion, a second issue, and a second suggestion. The first issue may be “incomplete text” and the corresponding first suggestion may be “put product name in text”, and the second issue may be “text color does not match brand's title color scheme” and the corresponding second suggestion may be “change font color scheme to blue”. Similarity, for a small image logo with coordinates (L₂, T₂, R₂, B₂), the output report 726 may indicate two issues and corresponding suggestions, including a third issue, a third suggestion, a fourth issue, and a fourth suggestion. The third issue may be “outline color does not match brand scheme” and the corresponding third suggestion may be “change the outline color scheme to red”, and the fourth issue may be “image should not contain gradient” and the corresponding fourth suggestion may be “replace the image with clear picture without gradient”. Further, for body text with coordinates (L₃, T₃, R₃, B₃), the output report 726 may indicate one issue and a corresponding suggestion, including a fifth issue, and a fifth suggestion. The fifth issue may be “references missing” and the corresponding fifth suggestion may be “add references to the body”. For Call To Action (CTA) button with coordinates (L₄, T₄, R₄, B₄), the output report 726 may indicate one issue and a corresponding suggestion, including a sixth issue, and a sixth suggestion. The sixth issue may be “long CTA text” and the corresponding sixth suggestion may be “replace the CTA text to more information”. The output report 726 serves as a critical tool for users, highlighting areas that require attention or correction. The output report 726 may detail specific non-compliance issues related to dimensions, visual alignment, text clarity, and adherence to established guidelines. By providing actionable insights, the process flow 700 enables users to make informed decisions about necessary adjustments, ensuring that the final image meets all relevant standards and expectations.

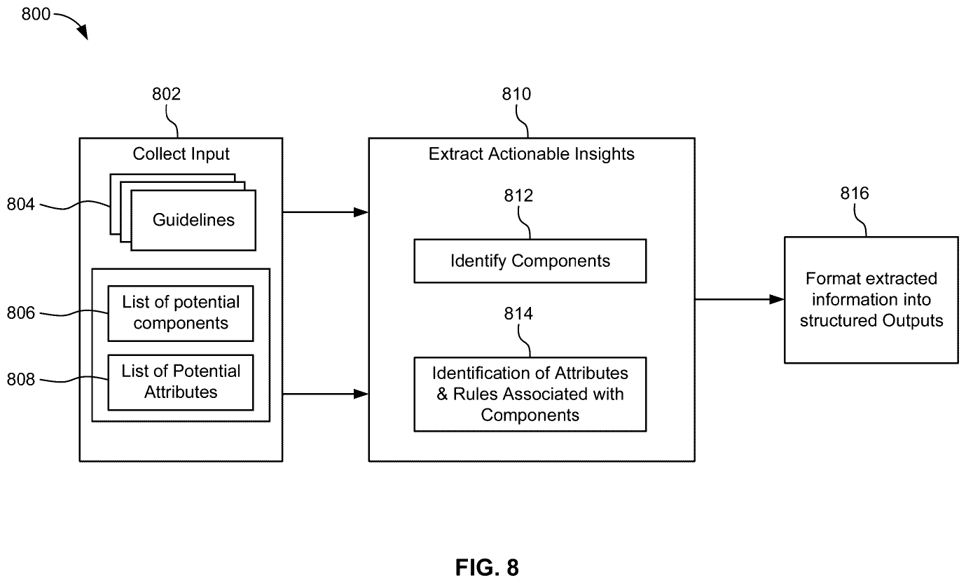

FIG. 8 illustrates a process flow 800 of generating rules governing allowable content, in accordance with implementations of the present disclosure. FIG. 8 is explained in conjunction with FIGS. 1-7. The process flow 800 is executed using the image compliance and modification system 114.

The process flow 800 begins with collecting input 802 that are crucial for establishing a framework for compliance validation. The input 802 includes guidelines 804 sourced from various PDFs and webpages. The PDFs and webpages may include industry standards, regulatory requirements, branding rules, and best practices that are essential for ensuring compliance in different contexts. By collecting the guidelines 804, a foundation is laid for understanding how specific elements may be presented visually and textually. In addition to the guidelines 804, a list of potential components 806 is compiled. The list of potential components 806 may not be exhaustive but may cover key elements relevant to the guidelines 804. The list of potential components 806 may include items such as text blocks, images, logos, buttons, and other graphical elements. Alongside the list of potential components 806, a list of potential attributes 808 is established, describing specific properties or characteristics of each component within the list of potential components 806, such as size, color, font style, alignment, and other defining features that contribute to compliance with the guidelines 804.

After collecting the input 802, the process flow 800 includes understanding (analyzing and interpreting) the guidelines 804 to extract actionable insights 810. To perform this step, components 812 may be identified. The identification of the components 812 involves breaking down previously identified components into more detailed sub-components or variations. For example, a component “text block” may be expanded into variations like “header text,” “body text,” and “caption text,” each governed by specific guidelines. Once the components 812 are expanded, a next task is to map the components to segments of input text corpus derived from the guidelines 804. The mapping ensures that each component is directly linked to relevant guidelines, creating a clear framework that defines where and how each component may be utilized based on extracted text. In conjunction with identification of the components 812, attributes and rules 814 associated with each of the component 812 may be identified, which involves analyzing the guidelines 804 to extract information/specific compliance rules that dictate how components need to be presented. For example, for a component “button,” attributes such as “background color,” “text color,” and “hover effect” may be defined, alongside rules like “the button must be prominent and have a contrasting color to ensure visibility”. The identification of the attributes and rules 814 is critical for ensuring that the components 812 adhere to the guidelines.

The process flow 800 further includes formatting the extracted information (e.g., data and the actionable insights 810 gathered from the guidelines and the analysis of components and attributes) into a structured output 816 that may be easily interpreted by machine learning models. For example, the structured output 816 involves creating JavaScript Object Notation (JSON) structures that encapsulate the rules, and the attributes associated with each of the components 812. This format may be chosen for compatibility with various environments and machine learning models. Each object in the output may include elements such as the component name (e.g., “button“), a list of specific attributes (e.g., color, size, and/or font), and compliance rules outlining requirements for proper usage (e.g., ”needs to be at least 44 px in height”). The structured output 816 allows the machine learning models to parse the information effectively, enabling compliance validation, generating recommendations, or facilitating automated content generation based on the established guidelines.

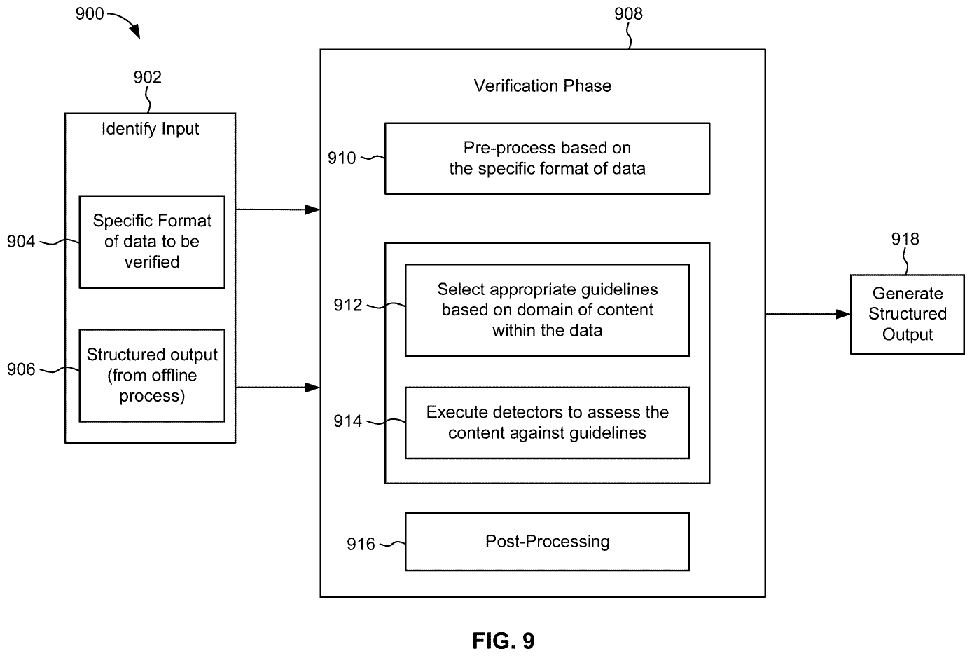

FIG. 9 illustrates an online process flow 900 of providing recommendations based on compliance validation of images, in accordance with implementations of the present disclosure. FIG. 9 is explained in conjunction with FIGS. 1-8. The online process flow 900 may be executed using the image compliance and modification system 114.

The online process flow 900 includes identifying input 902 that may be essential for conducting thorough assessments across various media types. The input 902 may include a specific format of data 904 to be verified, which includes documents, images, videos, and audio files. The format of the data 904 presents unique characteristics and requirements for validation. For example, the documents may include textual information and graphical elements that need to be checked for accuracy and compliance. The images require verification of visual content, including adherence to branding standards and clarity. The videos encompass both visual and auditory elements, necessitating checks for production quality and textual accuracy, while audio files demand assessments of clarity and content accuracy. The input 902 further includes a structured output 906 (same as the structured output 816) generated from the process flow 800. The structured output 906 encapsulates a wealth of information gathered during prior analyses, including rules, attributes, and guidelines relevant to the content being verified. The structured output 906 provides a roadmap for a verification process by defining the components involved, the specific attributes that need to be assessed, and the compliance rules that govern the acceptable standards for each media type. By integrating the structured output 906, content may be evaluated efficiently against predefined criteria.

Further, the online process flow 900 includes a verification phase 908. The verification phase 908 includes various sub-steps, starting with performing a pre-processing step 910 based on the specific format of the data 904. For the documents, the pre-processing step 910 may involve techniques such as table detection and recognition, text chunking, and logo detection to identify and categorize different elements within the documents. In case of images, OCR may be employed to extract text, while object detection techniques identify visual elements within the image. For audio files, speech-to-text (STT) technology transcribes spoken content into written form, making it easier to assess compliance. Similarly, videos require both STT for any spoken content and OCR for any text displayed on the screen.

Following the pre-processing step 910, the verification phase 908 involves selecting appropriate guidelines 912 based on domain of content within the data 904. The selection may be categorized into vertical and horizontal guidelines, which dictate standards for specific industries or content types.

Once the appropriate guidelines 912 are selected, detectors 914 may be executed to assess the content against the appropriate guidelines 912. Various checks may be performed depending on the media type. For typography, font identification and text copy checks ensure adherence to branding standards. For photography, assessments of compositional elements like the rule of thirds and depth of field are conducted. For video content, checks are performed on subtitle text attributes to ensure accuracy. Audio verification includes speaker diarization to identify different speakers, sentiment analysis to gauge emotional tone, and gender identification to determine the demographics of the speakers.

The verification phase 908 further includes a post-processing step 916, which involves merging or aggregating outputs from all pages, images, frames, and audio segments. The aggregation of the outputs ensures a comprehensive overview of verification results, facilitating a clearer understanding of compliance across all media types.

The online process flow 900 further includes generating a structured output 918 based on culmination of results (from the verification phase 908) that detail the rules that failed during compliance checks. The structured output 918 highlights specific issues found in the data 904 including the documents, images, video frame, or audio segment, providing a clear and actionable report of non-compliance. Each object of the structured output 918 may include details such as a type of media, a specific rule that is violated, and corresponding segment where an issue is identified. The structured output 918 not only serves as a record of results of the verification phase 908 but also enables users to easily identify and rectify compliance failures, ultimately enhancing the quality and effectiveness of the content produced.

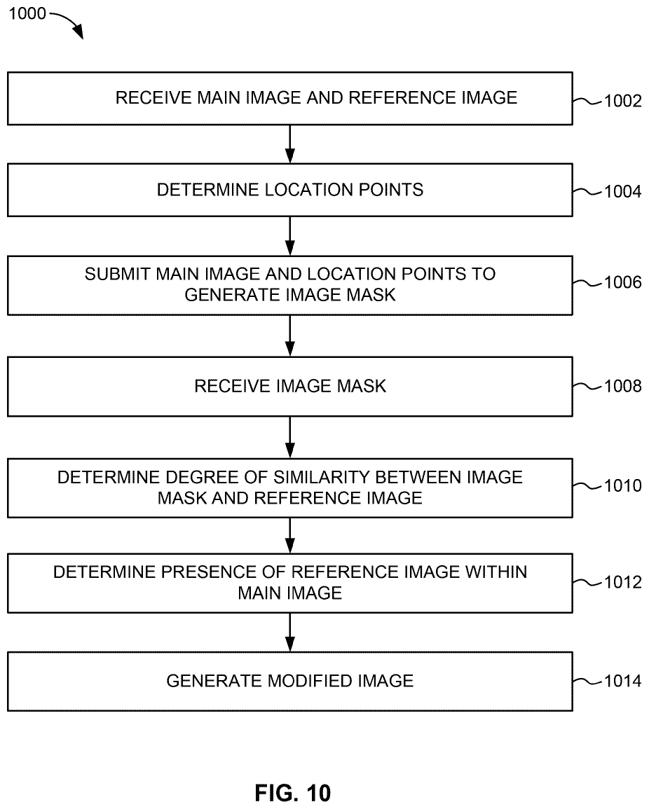

FIG. 10 is a flow diagram that presents an example method 1000 for modifying images, in accordance with implementations of the present disclosure. In some implementations, the method 1000 may be executed within the image compliance and modification system 114 and by the processor(s) 206 (shown in FIG. 2) using modules of the memory 208 (shown in FIG. 2). FIG. 10 is explained in conjunction with FIGS. 1-9.

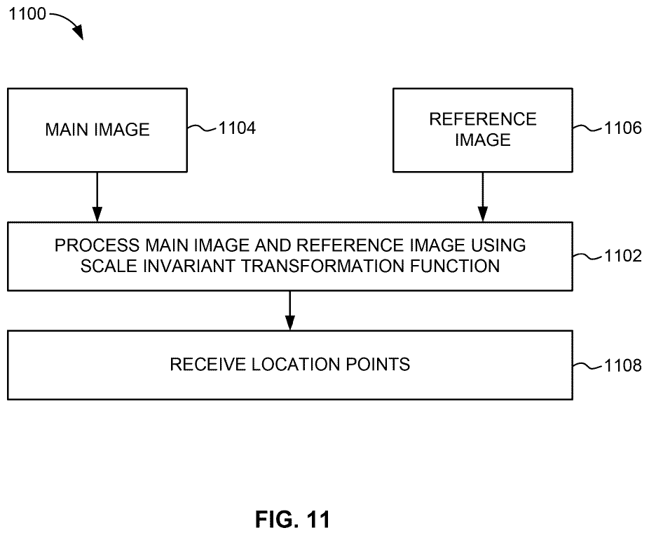

The method 1000 includes receiving 1002 a main image and a reference image. The main image serves as a primary focus for analysis and potential modification. The users 110 and 112, through the computing devices 102 and 104, respectively, may submit the main image to alter, enhance, or assess the main image according to specific rules. In contrast, the reference image acts as a secondary image, providing a benchmark for comparison with the main image. The method 1000 further includes determining 1004 one or more location points of content within the main image that may be a candidate for a match with the reference image. The one or more location points refer to specific coordinates or regions within the main image that highlight areas of interest or the content for further analysis or comparison. Non-limiting examples of methodologies to determine the location points for different types of content is explained further in FIGS. 11-13.

The method 1000 includes submitting 1006 the main image and the determined one or more location points to an image segmentation foundation model. An example of the image segmentation foundation model 224 includes a Segment Anything Model (SAM), which is explained already in detail in FIG. 2. The method 1000 includes receiving 1008, in response to the submitting, the image mask. The method 1000 further includes first determining 1010 a degree of similarity between the received generated image mask and the reference image. To determine the degree of similarity, the image mask may be applied to the main image. Further, the reference image may be compared to with content of the main image exposed through the applied image mask. The method 1000 includes second determining 1012, based on a result of the first determining, whether the reference image is present in the main image at the one or more location points.

The method 1000 includes generating 1014, in response to at least the second determining, a modified image from the main image. In an implementation, to generate the modified image, the reference image may be removed from the main image when the reference image is present in the main image at an allowable location. To generate the modified image various rules that govern allowable and/or required content in an image may be maintained. The removing may be in response to the reference image in the main image violating any of the rules that prohibit presence of the reference image. Further, in another implementation, to generate the modified image, a location of the reference image may be relocated in the main image when the reference image is present in the main image at an unallowable location. The relocating may be in response to at least the reference image being at a location in the main image in violation any of the rules that limit allowable locations of the reference image. In yet another implementation, to generate the modified image, the reference image may be added to the main image when the reference image is absent in the main image. The adding may be in response to absence of the reference image in the main image violating any of the rules that require the presence of the reference image or content similar to the reference image.

The rules may be maintained by: identifying one or more pages including guidelines within verbose documents, using a guideline filter, extracting and categorizing content from the identified one or more pages by applying topic modeling to the identified one or more pages, collecting metadata related to the extracted and categorized content, generating a prompt input using the verbose documents, the metadata, and one or more prompts selected from a prompts library, processing the prompt input using a large language model (LLM) to generate the rules, and storing the rules into a guidelines library. The prompt input has a structured machine interpretable format. This has been already explained in detail in conjunction with FIG. 3.

Further, in some implementations, text may be extracted from character regions within an image using the OCR. The character regions may be identified using a character segmentation model. Further, a coarse description of objects may be generated from object regions within the image, based on the extracted text, using a vision foundation model. Based on the coarse description, a granular description of the objects may be obtained, using the vision foundation model. The extracted text and the granular description may be analyzed against the rules. At least one of one or more non-compliant character regions and non-compliant object regions violating any of the plurality of rules may be identified. A usage of the image upon identification of at least one of the one or more non-compliant character regions and the non-compliant object regions may be restricted. This has been already explained in detail in conjunction with FIG. 6.

Further, in some implementations, a continuous feedback learning mechanism for topic modeling may be implemented to automatically select the rules based on various factors. The selected rules may be segregated at a finer level across different industry verticals. Geo-location data may be incorporated to refine the rules selection for specific regions. This has been already explained in detail in conjunction with FIG. 2.

FIG. 11 is a flow diagram that presents an example method 1100 for determining location points within an image, in accordance with implementations of the present disclosure. In some implementations, the method 1100 may be executed within the image compliance and modification system 114 and by the processor(s) 206 (shown in FIG. 2) using modules of the memory 208 (shown in FIG. 2). FIG. 11 is explained in conjunction with FIGS. 1-10.

The method 1100 includes processing 1102 the main image 1104 and the reference image 1106 using a scale invariant transformation function. The method 1100 further includes receiving 1108 the one or more location points, in response to processing of the main image and the reference image. For example, the content being assessed is a clear image of an object characterized by appropriate size and high or moderate resolution, quality, texture, and transparency. To ensure accurate comparison between the main image 1104 and the reference image 1106, the scale-invariant transformation function may be applied. The scale-invariant transformation function normalizes both the main image 1104 and the reference image 1106, accommodating differences in size, orientation, and angles that can arise from factors such as distance during capture or camera settings. By adjusting the main image 1104 and the reference image 1106 to a common scale and orientation, the scale-invariant transformation function eliminates discrepancies that may affect the accuracy of compliance assessments. Once the scale-invariant transformation function is applied, the next step involves processing the transformed main and reference images to identify coordinates and regions that need evaluation for compliance. This processing includes extracting distinct features, such as edges and contours, and utilizing pattern recognition to match these features between the two images (e.g., the main and the reference images). A result of the processing may be the location points that highlight areas of interest in the main image 1104, which needs to be complied with the rules or the guidelines.

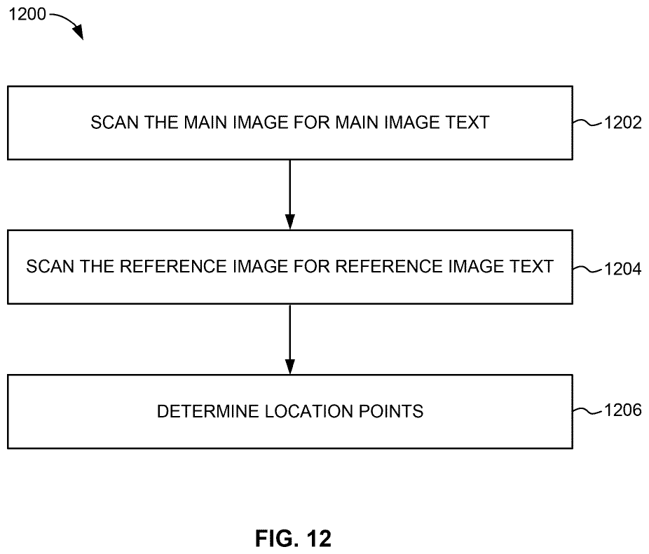

FIG. 12 is a flow diagram that presents an example method 1200 for determining location points within an image including textual data, in accordance with implementations of the present disclosure. In some implementations, the method 1200 may be executed within the image compliance and modification system 114 and by the processor(s) 206 (shown in FIG. 2) using modules of the memory 208 (shown in FIG. 2). FIG. 12 is explained in conjunction with FIGS. 1-10.

The method 1200 includes first scanning 1202 the main image using an OCR technique for main image text. Further, the method 1200 includes second scanning 1204 the reference image using the OCR technique for reference image text. The method 1200 further includes determining the one or more location points for a region in the main image that encloses text within the main image text matching the reference image text.

For example, the content being assessed, or the reference image may consist of text. In this case, the main image is scanned using the OCR to extract the main image text, and the reference image is similarly scanned to extract the reference image text. The scanning may occur simultaneously or sequentially. The method 1200 includes determining 1206 location points a region in the main image that include text matching the reference image text. The determination includes comparing the extracted main image and reference image texts to identify matches and performing geometric analysis to evaluate the spatial coordinates of the matching text, resulting in identification of the region in the main image that correspond to the reference image text.

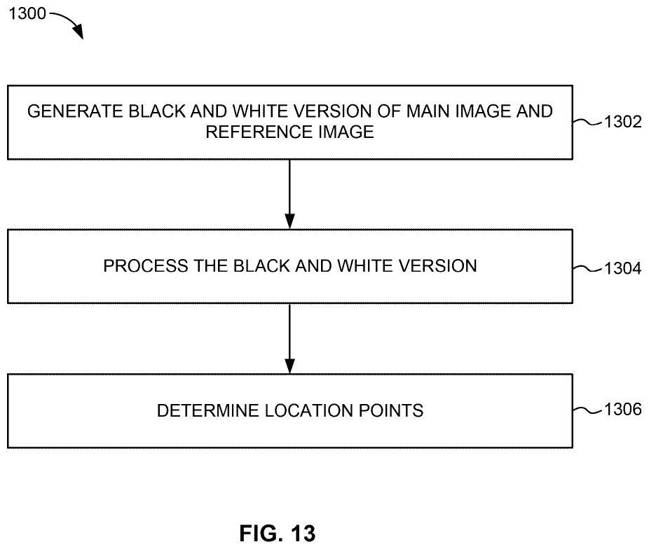

FIG. 13 is a flow diagram that presents an example method 1300 for determining location points for a low-resolution image, in accordance with implementations of the present disclosure. In some implementations, the method 1200 may be executed within the image compliance and modification system 114 and by the processor(s) 206 (shown in FIG. 2) using modules of the memory 208 (shown in FIG. 2). FIG. 13 is explained in conjunction with FIGS. 1-10.

The method 1300 includes generating 1302, using an edge detector program, a black and white version of the main image and the reference image. For example, the content to be assessed or the reference image may include a small or low-quality image, such as a blurred image. In this case, the black and white versions of both the main and reference images may be generated using the edge detector program. This program highlights boundaries by analyzing pixel values to identify sharp transitions in intensity or color. The edge detector program converts the main and the reference images to grayscale and applies thresholding to produce binary images, clearly defining object edges.

The method 1300 further includes processing 1304 the black and white version of the main image and the reference image using a scale invariant transformation function, which is explained in detail in FIG. 2. The method 1300 includes determining 1306 the one or more location points in response to processing the black and white version.

Implementations of the present disclosure provide technical solutions to multiple technical problems that arise in the context of assessment of image compliance. Implementations of the present disclosure provide advantages, particularly for brands seeking to maintain consistent messaging and adherence to ethical rules or standards. By leveraging technologies like OCR and image segmentation foundation model, the disclosure efficiently evaluates images against predefined guidelines, ensuring compliance with brand values and industry regulations. The image compliance and modification system 114 not only reduces the risk of human error in content assessment but also streamlines a process of identifying and rectifying compliance issues before publication. Furthermore, the image compliance and modification system 114 has an ability to modify images such as removing conflicting elements or adding necessary content, which enables brands to uphold their image and messaging without extensive manual intervention. This ability leads to cost savings, quicker turnaround times for marketing materials, and ultimately, a stronger, more trustworthy brand presence in the market.

Additionally, the disclosure provides generation of rules or guidelines for allowable content which presents various advantages, particularly in ensuring compliance and consistency across various industries. By utilizing techniques such as NLP and LLMs, industries may efficiently sift through extensive documents to extract relevant guidelines, significantly reducing manual effort and time. The generation of rules and guidelines not only enhances accuracy in identifying pertinent content but also facilitates creation of well-structured, easily accessible guidelines. As a result, the disclosure enhances operational efficiency, ensuring that industries may uphold their standards and navigate regulatory landscapes with confidence.

The disclosure automates evaluation of images against predefined rules, which reduces reliance on manual processes. The automation addresses problems of human errors, which is prevalent in manual image assessments, thereby enhancing accuracy and efficiency. The disclosure utilizes techniques such as Optical Character Recognition (OCR) and image segmentation foundation models, which improves capability to analyze and modify images in a precise manner. Moreover, the disclosure scalability of compliance assessment by allowing processing of large volumes of images rapidly, ensuring that brands may maintain compliance across various industries without significant delays. The disclosure uses a scale-invariant transformation function that allows for robust comparisons between images, accommodating variations in size and orientation. This robust comparison addresses challenge faced in image processing, thereby improving reliability of the compliance assessment.

Further, the disclosure provides an ability to modify images by removing, relocating, or adding content based on the predefined rules, to maintain brand integrity. The modification feature enables proactive management of compliance issues before publication, which is a significant advancement in the field of digital content management. The use of Natural Language Processing (NLP) and Large Language Models (LLMs) for generating the rules from extensive documents enhances accuracy and relevance of the rules or guidelines. This not only streamlines the Image compliance process but also ensures that brands adhere to evolving industry standards, providing a dynamic solution to compliance challenges.

By minimizing manual intervention and optimizing the image compliance process, the disclosure leads to cost savings and quicker turnaround times (e.g., improved operational efficiency) for industries.

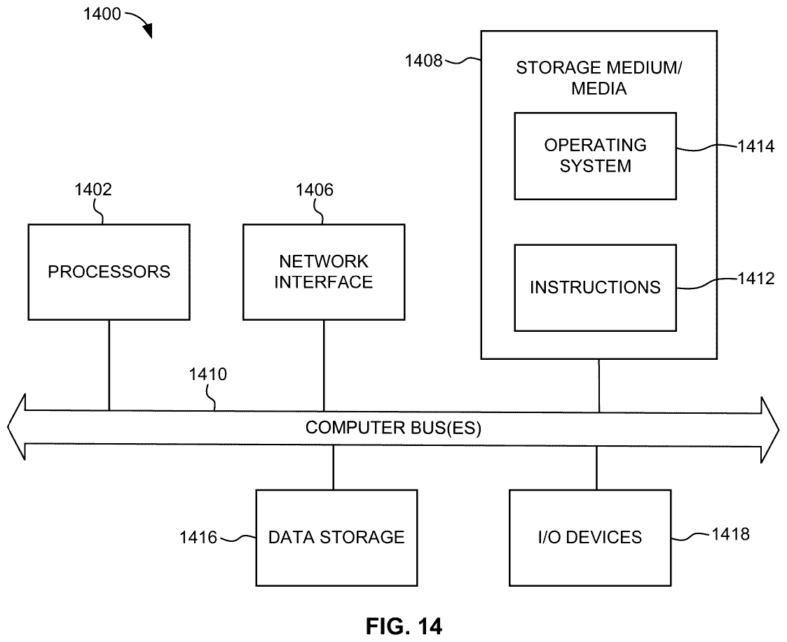

FIG. 14 illustrates a computer system 1400 that may be used to implement the image compliance and modification system 114. More particularly, computing machines such as desktops, laptops, smartphones, tablets, and/or wearable electronic devices which may be used for verification of image compliance and modifying the images and may have the structure of the computer system 1400. The computer system 1400 may include additional components not shown and that some of the process components described may be removed and/or modified. In another example, a computer system 1400 may be deployed on external-cloud platforms such as cloud, internal corporate cloud computing clusters, organizational computing resources, and/or the like.

The computer system 1400 includes processors 1402, such as a central processing unit, a controller, an application specific integrated circuit (ASIC), or another type of processing circuit, input/output (I/O) devices 1418, such as a display, a mouse, a keyboard, etc., a network interface 1406, such as a Local Area Network (LAN) interface, a wireless 802.11x interface, a 3G, 4G, 5G, or 6G mobile WAN or a WiMax WAN, and a computer-readable medium 1408. Each of these components may be operatively coupled each other via one or more computer bus(es) 1410. The computer-readable medium 1408 may be any suitable medium that participates in providing instructions to the processors 1402 for execution. For example, the computer-readable medium 1408 may be non-transitory or non-volatile medium, such as a magnetic disk or solid-state non-volatile memory or volatile medium such as RAM. The instructions or modules stored on the computer-readable medium 1408 may include machine-readable or machine-executable instructions or code 1412 executed by the processors 1402 that cause the processors 1402 to perform the methods and functions of the image compliance and modification system 114.

The image compliance and modification system 114 may be implemented as software stored on a non-transitory computer-readable medium and executed by the processors 1402. For example, the computer-readable medium 1408 may store an operating system 1414, such as MAC OS, MS WINDOWS, UNIX, or LINUX, and code 1412 for the image compliance and modification system 114. The operating system 1414 may be multi-user, multiprocessing, multitasking, multithreading, real-time, and the like. For example, during runtime, the operating system 1414 and the code for the image compliance and modification system 114 are executed by the processors 1402.

The computer system 1400 may include a data storage 1416, which may include non-volatile data storage. The data storage 1416 stores any data used or generated by the image compliance and modification system 114.

The network interface 1406 connects the computer system 1400 to external systems for example, via a LAN. Also, the network interface 1406 may connect the computer system 1400 to the Internet. For example, the computer system 1400 may connect to web browsers and other external applications and systems via the network interface 1406.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (e.g., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term computing system encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor may receive instructions and data from a read only memory or a random-access memory or both. Elements of a computer may include a processor for performing instructions and one or more memory devices for storing instructions and data. Generally, a computer may also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (LAN) and a wide area network (WAN), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it may be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A method for modifying an image, comprising:
receiving a main image and a reference image;
determining one or more location points of content within the main image that is a candidate for a match with the reference image;
submitting the main image and the determined one or more location points to an image segmentation foundation model;
receiving, in response to the submitting, an image mask;
first determining a degree of similarity between the received image mask and the reference image;
second determining, based on a result of the first determining, whether the reference image is present in the main image at the one or more location points; and
generating, in response to at least the second determining, a modified image from the main image, by at least:
removing the reference image from the main image when the reference image is present in the main image at an allowable location,
relocating a location of the reference image in the main image when the reference image is present in the main image at an unallowable location, or
adding the reference image to the main image when the reference image is absent in the main image.

2. The method of claim 1, wherein determining the one or more location points further comprises:
processing the main image and the reference image using a scale invariant transformation function; and
receiving the one or more location points, in response to processing of the main image and the reference.

3. The method of claim 1, wherein determining the one or more location points further comprises:
first scanning the main image using an Optical Character Recognition (OCR) technique for main image text;
second scanning the reference image using the OCR technique for reference image text; and
determining one or more location points for a region in the main image that encloses text within the main image text matching the reference image text.

4. The method of claim 1, wherein determining the one or more location points further comprises:
generating, using an edge detector program, a black and white version of the main image and the reference image;
processing the black and white version of the main image and the reference image using a scale invariant transformation function; and
determining one or more location points in response to processing the black and white version.

5. The method of claim 1, wherein first determining a degree of similarity between the received image mask and the reference image further comprises:
applying the image mask to the main image; and
comparing the reference image with content of the main image exposed through the applied image mask.

6. The method of claim 1, further comprising:
maintaining a plurality of rules that govern allowable and/or required content in an image, wherein:
the removing is in response to at least the reference image in the main image violating any of the plurality of rules that prohibit presence of the reference image;
the relocating is in response to at least the reference image being at a location in the main image in violation any of the plurality of rules that limit allowable locations of the reference image; and
the adding is in response to absence of the reference image in the main image violating any of the plurality of rules that require the presence of the reference image or content similar to the reference image.

7. The method of claim 6, wherein maintaining a plurality of rules further comprises:
identifying one or more pages including guidelines within verbose documents, using a guideline filter;
extracting and categorizing content from the identified one or more pages by applying topic modeling to the identified one or more pages;
collecting metadata related to the extracted and categorized content;
generating a prompt input using the verbose documents, the metadata, and one or more prompts selected from a prompts library, wherein the prompt input has a structured machine interpretable format;
processing the prompt input using a large language model (LLM) to generate the plurality of rules; and
storing the plurality of rules into a guidelines library.

8. The method of claim 6, further comprising:
extracting text from character regions within an image using the OCR, wherein the character regions are identified using a character segmentation model;
generating, based on the extracted text, a coarse description of objects from object regions within the image, using a vision foundation model;
obtaining, using the vision foundation model and based on the coarse description, a granular description of the objects by cropping the object regions;
analyzing the extracted text and the granular description against the plurality of rules;
identifying at least one of one or more non-compliant character regions and non-compliant object regions violating any of the plurality of rules; and
restricting a usage of the image upon identification of at least one of the one or more non-compliant character regions and the non-compliant object regions.

9. The method of claim 7, further comprising:
implementing a continuous feedback learning mechanism for topic modeling to automatically select the plurality of rules based on various factors;
segregating the selected plurality of rules at a finer level across different industry verticals; and
incorporating geo-location data to refine the plurality of rules selection for specific regions.

10. A non-transitory computer readable media storing instructions programmed to cooperate with electronic computer hardware in combination with software to perform operations for modifying an image, comprising:
receiving a main image and a reference image;
determining one or more location points of content within the main image that is a candidate for a match with the reference image;
submitting the main image and the determined one or more location points to an image segmentation foundation model;
receiving, in response to the submitting, the image mask;
first determining a degree of similarity between the received image mask and the reference image;
second determining, based on a result of the first determining, whether the reference image is present in the main image at the one or more location points; and
generating, in response to at least the second determining, a modified image from the main image, by at least:
removing the reference image from the main image when the reference image is present in the main image at an allowable location,
relocating a location of the reference image in the main image when the reference image is present in the main image at an unallowable location, or
adding the reference image to the main image when the reference image is absent in the main image.

11. The non-transitory computer readable media of claim 10, wherein determining one or more location points further comprises:
processing the main image and the reference image using a scale invariant transformation function; and
receiving the one or more location points, in response to processing of the main image and the reference.

12. The non-transitory computer readable media of claim 10, wherein determining one or more location points further comprises:
first scanning the main image using an Optical Character Recognition (OCR) technique for main image text;
second scanning the reference image using the OCR technique for reference image text; and
determining one or more location points for region in the main image that encloses text within the main image text matching the reference image text.

13. The non-transitory computer readable media of claim 10, wherein the determining one or more location points further comprises:
generating, using an edge detector program, a black and white version of the main image and the reference image;
processing the black and white version of the main image and the reference image using a scale invariant transformation function; and
determining one or more location points in response to processing the black and white version.

14. The non-transitory computer readable media of claim 10, wherein first determining a degree of similarity between the received image mask and the reference image further comprises:
applying the image mask to the main image;
comparing the reference image with content of the main image exposed through the applied image mask.

15. A system for modifying an image comprising:
a processor;
a non-transitory computer readable memory storing instructions programmed to cooperate with the processor to perform operations for modifying an image, comprising:
receiving a main image and a reference image;
determining one or more location points of content within the main image that is a candidate for a match with the reference image;
submitting the main image and the determined one or more location points to an image segmentation foundation model;
receiving, in response to the submitting, the image mask;
first determining a degree of similarity between the received image mask and the reference image;
second determining, based on a result of the first determining, whether the reference image is present in the main image at the one or more location points; and
generating, in response to at least the second determining, a modified image from the main image, by at least:
removing the reference image from the main image when the reference image is present in the main image at an allowable location,
relocating a location of the reference image in the main image when the reference image is present in the main image at an unallowable location, or
adding the reference image to the main image when the reference image is absent from the main image.

16. The system of claim 15, wherein determining one or more location points further comprises:
processing the main image and the reference image using a scale invariant transformation function; and
receiving the one or more location points, in response to processing of the main image and the reference.

17. The system of claim 15, wherein determining one or more location points further comprises:
first scanning the main image using an Optical Character Recognition (OCR) technique for main image text;
second scanning the reference image using the OCR technique for reference image text; and
determining one or more location points for a region in the main image that encloses text within the main image text matching the reference image text.

18. The system of claim 15, wherein determining one or more location points further comprises:
generating, using an edge detector program, a black and white version of the main image and the reference image;
processing the black and white version of the main image and the reference image using a scale invariant transformation function; and
determining one or more location points in response to processing the black and white version.

19. The system of claim 15, wherein the first determining a degree of similarity between the received image mask and the reference image further comprises:
applying the image mask to the main image; and
comparing the reference image with content of the main image exposed through the applied image mask.

20. The system of claim 15, wherein the operations further comprising:
maintaining a plurality of rules that govern allowable and/or required content in an image, wherein:
the removing is in response to at least the reference image in the main image violating any of the plurality of rules that prohibit presence of the reference image;
the relocating is in response to at least the reference image being at a location in the main image in violation any of the plurality of rules that limit allowable locations of the reference image; and
the adding is in response to absence of the reference image in the main image violating any of the plurality of rules that require the presence of the reference image or content similar to the reference image.
